(19) United States
(12) Patent Application Publication
(10) Pub. No.: US 2019/0195292 A1
(43) Pub. Date: Jun. 27, 2019

(54) Clutch Local Peak Temperature Real Time Predictor and Applications

(71) Applicant: Caterpillar Inc., Peoria, IL (US)

(72) Inventors: Chunhui Pan, Edwards, IL (US); James Grant Cotner, Washington, IL (US); Xuefei Hu, Dunlap, IL (US); Zhaoxu Dong, Dunlap, IL (US); Yong Sun, Dunlap, IL (US); Yanchai Zhang, Dunlap, IL (US)

(73) Assignee: Caterpillar Inc., Peoria, IL (US)

(21) Appl. No.: 15/852,292

(22) Filed: Dec. 22, 2017

(51) Int. Cl. F16D 13/02

(52) U.S. Cl. CPC F16D 13/02; F16D 2500/5102; F16D 2300/18; F16D 2500/70424; F16D 2500/7043; F16D 2500/1021; F16D 2500/1081; F16D 2500/70474; F16D 2300/02

(57) ABSTRACT

Methods and apparatus for predicting clutch local peak temperatures in real time and controlling engagement of a friction clutch are disclosed. The clutch local peak temperature prediction can take into account machine operating parameters such as clutch control current, clutch shaft speed and clutch load to determine clutch local peak temperatures at hot spots within the friction clutch. A thermal-mechanical finite element analysis model may be developed for the friction clutch and used to generate a surrogate model of the friction clutch that can be used by an electronic control module of the machine to predict the local peak temperature of the friction clutch in real time and control engagement and disengagement of the friction clutch to maintain the local peak temperature below a critical peak temperature above which damage to the components of the friction clutch may occur.

### TECHNICAL FIELD

The present disclosure relates generally to friction clutches in work machines, and more particularly, to apparatus and methods for predicting local peak temperatures in friction clutches and controlling the friction clutches to reduce failure and to predict preventative maintenance timing.

### BACKGROUND

Machines such as articulated haul trucks and off-highway mining trucks include an engine that provides power to wheels of the trucks via a planetary-type transmission. A planetary-type transmission is generally made up of at least three different elements, including a sun gear, a planet carrier having at least one set of planet gears, and a ring gear. The planet gears of the planet carrier mesh with the sun gear and the ring gear. One of the sun gear, planet carrier and ring gear is driven as an input to the transmission, while another of the sun gear, planet carrier, and ring gear rotates as an output of the transmission. The sun gear, planet carrier, planet gears, and ring gear can all rotate simultaneously to transmit power from the input to the output at a first ratio of speed-to-torque and in a forward direction or, alternatively, one of the sun gear, planet carrier, and ring gear can be selectively held stationary or locked to rotate with another gear and thereby transmit power from the input to the output at a second ratio of speed-to-torque and/or in a reverse direction. The change in rotational direction and/or speed-to-torque ratio of the transmission depends upon the number of teeth in the sun and ring gears, the gear(s) that is selected as the input, the gear(s) that is selected as the output, and which gear, if any, is held stationary or rotationally locked with another gear. A hydraulic clutch (also commonly referred to as a brake) is used to hold particular gears stationary and/or to lock the rotation of particular gears together.

The clutches in the transmission typically rely on frictional forces for their operation. The purpose of friction clutches is to connect a moving member to another that is moving at a different speed or stationary, often to synchronize the speeds, and/or to transmit power. The friction clutches include plates connected to and rotating with each of the connected components. The plates are pressed together by a device such as a hydraulic piston with sufficient force to create frictional engagement between the plates to cause the connected components to rotate together. As little slippage as possible between the engaged plates is desired. However, because friction is involved in locking the clutches, heat is generated in the clutches. It is possible for the heat to rise to a level that can cause damage to the components of the clutches. Moreover, repeated heating cycles in the clutches over time can cause degradation of the components and the performance of the clutches so that periodic maintenance or replacement is necessary before the clutches fail during operation of the machine. Therefore, the clutch temperature of clutches can be a key indicator of clutch durability and performance.

Systems exist for determining and monitoring clutch temperatures in friction clutches. An example of such a system is provided in U.S. Pat. No. 8,879,979, issued to Hebbale et al. on Nov. 25, 2014, entitled “Thermal Model for Dry Dual Clutch Transmission” (“'979 patent”). The reference discloses a method of determining temperatures for a dry dual clutch mechanism including one or more steps, such as determining a first heat input from a first clutch and determining a second heat input from a second clutch. The second clutch is separated from the first clutch by a center plate. The method also includes determining a housing air temperature of housing air within a bell housing case of the dry dual clutch mechanism. A thermal model is applied with the determined first heat input and second heat input. The thermal model includes temperature states for at least the first clutch, the second clutch, and the center plate. From the thermal model, the method determines at least a first clutch temperature and a second clutch temperature. The method includes executing a control action with the determined first clutch temperature and second clutch temperature.

Prior art systems such as that shown in the '979 patent typically utilize energy dissipation and average temperature distributions to monitor friction clutches. However, friction clutches experience peak temperatures at localized areas within the friction clutches, typically at locations on the clutch plates. The existence of local peak temperatures, also known as thermoelastic instability (TEI), is typically not accounted for in the prior art systems. The omission of the local peak temperatures leads to the underestimation of the clutch temperature so that the prior art systems can fail to accurately predict the clutch durability and performance, and thereby increase the risk of clutch failures during operation of the machine.

### SUMMARY OF THE DISCLOSURE

In one aspect of the present disclosure, a method for determining a local peak temperature for a friction clutch in a machine and controlling engagement of the friction clutch using the local peak temperature, wherein the local peak temperature is a temperature at a hot spot of the friction clutch. The method may include determining current operating parameter values of operating parameters of the machine, determining a current local peak temperature for the friction clutch based on the current operating parameter values, comparing the current local peak temperature for the friction clutch to a critical peak temperature for the friction clutch, maintaining engagement of the friction clutch in response to determining that the current local peak temperature is less than the critical peak temperature, and disengaging the friction clutch in response to determining that the current local peak temperature is greater than the critical peak temperature.

In another aspect of the present disclosure, a machine. The machine may include an engine, traction devices, a friction clutch operatively connecting the engine to the traction devices and selectively engageable to transmit torque output by the engine to the traction devices, a friction clutch actuator operatively connected to friction clutch and actuatable in response to a clutch control current to selectively engage and disengage the friction clutch, and an electronic control module (ECM) operatively connected to the engine and the friction clutch. The ECM may be programmed to determine current operating parameter values of operating parameters of the machine, determine a current local peak temperature for the friction clutch based on the current operating parameter values, compare the current local peak temperature for the friction clutch to a critical peak temperature for the friction clutch, transmit the clutch control current to the friction clutch actuator to maintain engagement of the friction clutch in response to determining that the current local peak temperature is less than the critical peak temperature, and cease transmitting the clutch control current to the friction clutch actuator to disengage the friction clutch in response to determining that the current local peak temperature is greater than the critical peak temperature.

In a further aspect of the present disclosure, a method for determining a local peak temperature for a friction clutch in a machine and controlling engagement of the friction clutch using the local peak temperature, wherein the local peak temperature is a temperature at a hot spot of the friction clutch. The method may include detecting operating parameters of the machine, inputting operating parameter values corresponding to the operating parameters into a surrogate model of the friction clutch, determining, in the surrogate model, a current local peak temperature for the friction clutch, outputting, from the surrogate model, the current local peak temperature for the friction clutch, comparing the current local peak temperature for the friction clutch to a critical peak temperature for the friction clutch, maintaining engagement of the friction clutch in response to determining that the current local peak temperature is less than the critical peak temperature, and disengaging the friction clutch in response to determining that the current local peak temperature is greater than the critical peak temperature.

These and additional aspects are defined by the claims of this patent.

### BRIEF DESCRIPTION OF THE DRAWINGS

FIG. 1 is a schematic illustration of an exemplary machine having a multi-clutch transmission in which clutch local peak temperature real time prediction in accordance with the present disclosure can be implemented;

FIG. 2 is a table depicting exemplary gear combinations for the transmission of FIG. 1;

FIG. 3 is a schematic illustration of an exemplary hydraulic circuit including clutch actuators for friction clutches of the transmission of FIG. 1;

FIG. 4 is a block diagram of control components that may implement clutch local peak temperature real time prediction in accordance with the present disclosure in the machine and transmission of FIG. 1;

FIG. 5 is a plan view of an exemplary clutch plate for the clutches of the transmission in the machine of FIG. 1 indicating exemplary locations of hot spots;

FIG. 6 is a flow diagram of a friction clutch surrogate model development routine in accordance with the present disclosure;

FIG. 7 is a flow diagram of a local peak temperature prediction and friction clutch control routine in accordance with the present disclosure; and

FIG. 8 is a flow diagram of a proactive friction clutch maintenance routine in accordance with the present disclosure.

### DETAILED DESCRIPTION

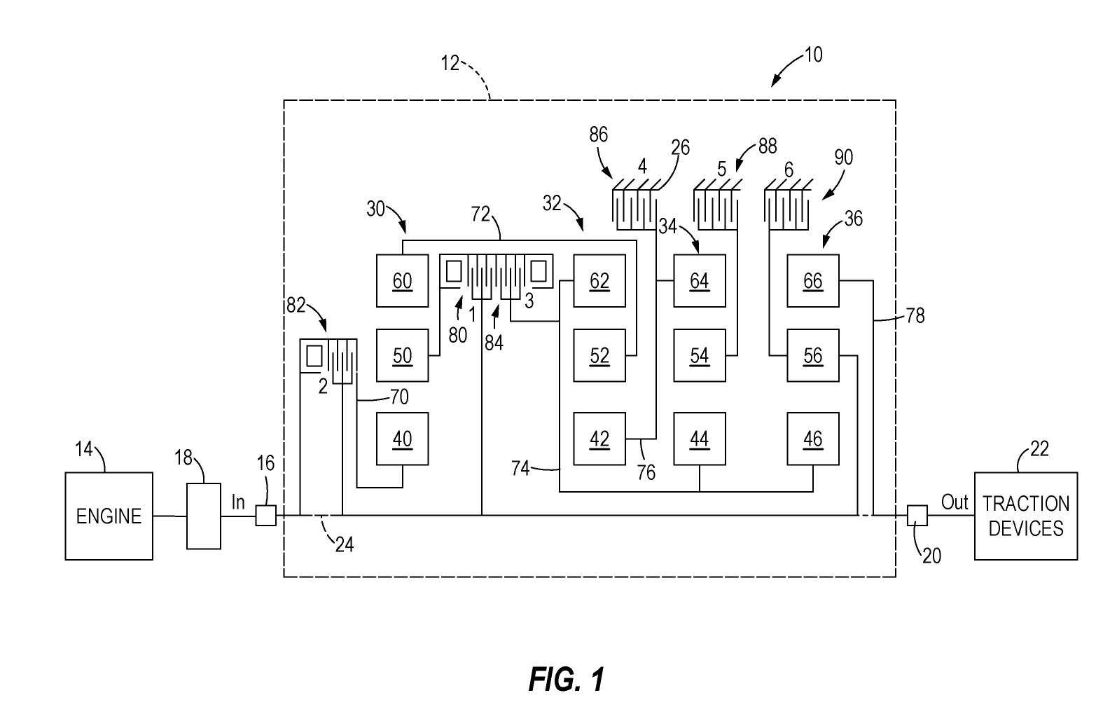

Referring to FIG. 1, an exemplary machine 10 is schematically illustrated in which real time prediction of clutch local peak temperatures and clutch control in accordance with the present disclosure may be implemented. The machine 10 includes an exemplary transmission 12 having a plurality of friction clutches for control of shifting the transmission 12 between available forward and reverse gears. The machine 10 may be a mobile machine that may perform predetermined tasks at a worksite. For example, the machine 10 may embody a mobile machine such as an off-highway mining truck, a wheel loader, a motor grader, an articulated haul truck, or any other mobile machine known in the art. The worksite may include, for example, a mine site, a landfill, a quarry, a construction site, or another type of worksite. The predetermined tasks performed by the machine 10 may require the machine 10 to traverse the worksite between different destinations. Accordingly, the transmission 12 may be a component of a power train of the machine 10 that facilitates travel between the different destinations at the worksite.

The power train of the machine 10 may generally include an engine 14 and the transmission 12. The engine 14 may embody any type of engine known in the art, for example, a diesel, gasoline, or gaseous-fuel powered, internal combustion engine configured to generate a mechanical power output. The transmission 12 may include an input member 16 such as an input shaft connecting the transmission 12 to the mechanical power output of the engine 14 via a torque converter 18, for example, and an output member 20 connecting the transmission 12 to one or more traction devices 22, such as wheels or tracks. As will be described in more detail below, the transmission 12 may embody a mechanical step-change transmission having at least one reverse gear and a plurality of forward gears. Each of the different gears may be manually or automatically selected by an operator to provide a different ratio of speed-to-torque in either the forward or reverse travel directions.

FIG. 1 schematically illustrates one half of the transmission 12 located to the side of a rotational axis of symmetry (axis) 24. The input member 16 and the output member 20 may be aligned along the axis 24. The transmission 12 may generally include a stationary housing 26 and four different planetary gear assemblies 30, 32, 34, 36 disposed within the housing 26 and rotatably supported and aligned along the axis 24. It is contemplated that the transmission 12 could include a greater or lesser number of planetary gear assemblies, as desired to provide the necessary gears to drive the machine 10 over the worksite. The structure of the different gears, input members, output members and connections there between can be achieved using conventional components, and those skilled in the art will understand that alternative transmission assembly arrangements may have local peak temperature real time prediction and clutch control in accordance with the present disclosure implemented therein.

In the disclosed embodiment, each of planetary gear assemblies 30-36 may include multiple interconnected components. Specifically, each of planetary gear assemblies 30-36 may include a sun gear 40-46, a planet carrier 50-56, and a ring gear 60-66, respectively. The sun gear 40 of the planetary gear assembly 30 may be fixed to rotate with the input member 16 via a coupling 70, while the ring gear 60, also of the planetary gear assembly 30, may be fixed to rotate with the planet carrier 52 of the planetary gear assembly 32 via a coupling 72. The ring gear 62 of the planetary gear assembly 32 may be fixed to rotate with the sun gears 44 and 46 of the planetary gear assemblies 34, 36 via a coupling 74. The sun gear 42 of the planetary gear assembly 32 may be fixed to rotate with the ring gear 64 of the planetary gear assembly 34 via a coupling 76. Finally, the ring gear 66 of the planetary gear assembly 36 may be fixed to rotate with the output member 20 via a coupling 78.

The transmission 12 may also include a plurality of friction clutches 80-90 selectively actuated to exert torque on portions of the couplings 70-78, the sun gears 40-46, the planet carriers 50-56, and/or the ring gears 60-66 that resist relative rotations between components and thereby rotationally lock the components to each other and/or to housing 26 in a variety of different configurations. These connections may facilitate a modification of the speed-to-torque ratio and/or the rotational direction received at the input member 16 relative to the speed-to-torque ratio and rotational direction delivered to the output member 20.

In the disclosed embodiment, the transmission 12 includes six different friction clutches 80-90. It is contemplated, however, that the transmission 12 could include a greater or lesser number of friction clutches, as desired. The friction clutch 80 may be configured to selectively connect the planet carrier 56 with the planet carrier 50. The friction clutch 82 may be configured to selectively connect the planet carrier 56 to the coupling 70, that is, to the input member 16 and the sun gear 40. The friction clutch 84 may be configured to selectively connect the planet carrier 50 to the coupling 74, that is, to the sun gears 44, 46 and the ring gear 62. The friction clutch 86 may be configured to selectively connect the coupling 76, that is, the sun gear 42 and the ring gear 64, to the housing 26. The friction clutch 78 may be configured to selectively connect the planet carrier 54 to the housing 26. The friction clutch 90 may be configured to selectively connect the planet carrier 56 to the housing 26.

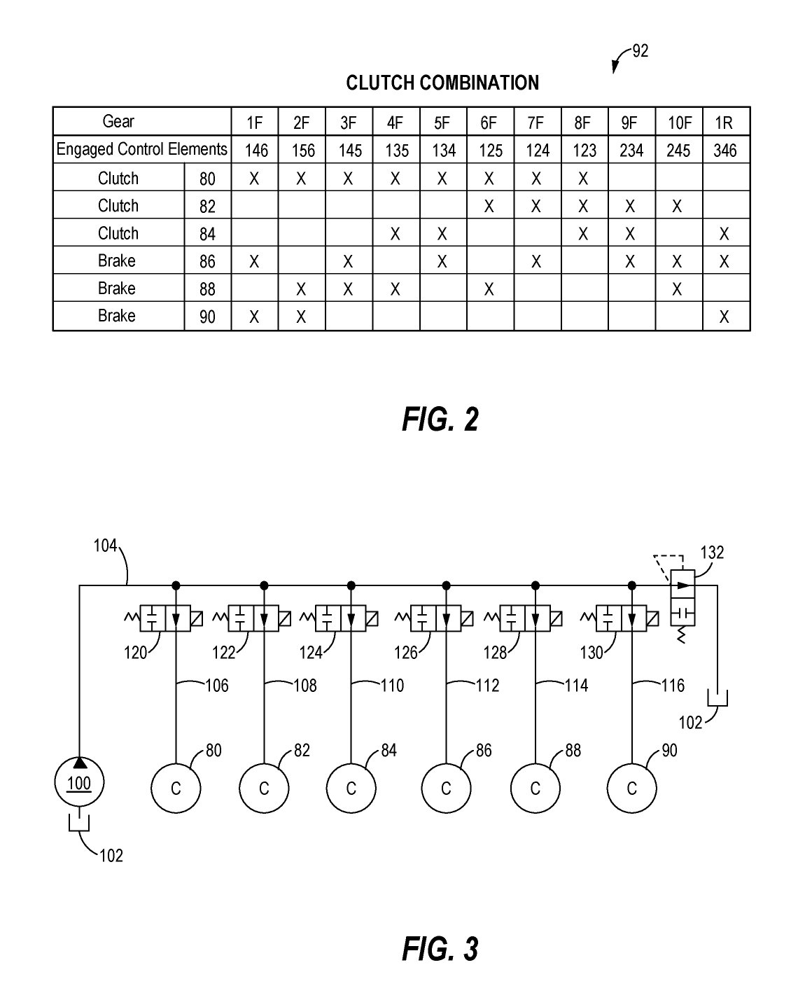

FIG. 2 illustrates a truth table 92 describing possible engagement combinations of the friction clutches 80-90, which establish ten forward gear ratios and one reverse gear ratio between the input member 16 and the output member 20 by way of the planetary gear assemblies 30-36. For example, to achieve the first forward gear ratio, the friction clutches 80, 86, 90 are shown to be simultaneously actuated to engage the corresponding components and thereby rotationally lock the corresponding components. Similarly, to achieve the fourth forward gear ratio, the friction clutches 80, 84, 88 are shown to be simultaneously actuated to engage and rotationally lock the corresponding components. In another example, the reverse gear ratio is shown to be achieved by simultaneously actuating the friction clutches 84, 86, 90 to engage and rotationally lock the corresponding components.

As shown in FIG. 3, the friction clutches 80-90 may be selectively supplied with hydraulic fluid to engage and connect the corresponding components described above. In particular, the transmission 12 may include a pump 100 configured to draw fluid from a low pressure supply 102, pressurize the fluid, and direct the pressurized fluid in parallel to the friction clutches 80-90 by way of a manifold 104 and a plurality of distribution lines 106, 108, 110, 112, 114, 116, respectively. Each of the friction clutches 80-90 may include one or more interior actuating chambers that, when filled with the pressurized fluid, displaces one or more pistons moving the piston(s) toward one or more clutch plates (not shown). As a piston “touches up” to a clutch plate, the actuating chamber(s) of the friction clutch 80-90 is full of fluid and the friction clutch 80-90 is engaged to rotationally lock the corresponding components. As described in connection with FIG. 2 above, the combination of engaged friction clutches 80-90 may determine the gear and the rotational direction of transmission 12.

A plurality of clutch control valves 120, 122, 124, 126, 128, 130 may be disposed within the distribution lines 106-116, respectively, between the manifold 104 and the corresponding friction clutches 80-90. The clutch control valves 120-130 may be selectively energized, based on operator or automatic transmission controller commands, to regulate flows of pressurized fluid to the interior actuating chambers of the friction clutches 80-90. In one example, each of the clutch control valves 120-130 may include a two-position, two-way valve mechanism (not shown) that is solenoid operated to actuate one or more of the friction clutches 80-90 in response to receiving a clutch control current. Each of the valve mechanisms may be movable between an open or flow-passing position at which fluid is allowed to flow into an associated actuating chamber, and a closed or flow-blocking position at which fluid flow is blocked from the actuating chamber. It is contemplated that each clutch control valve 120-130 may include additional or different mechanisms, if desired, such as a proportional valve mechanism, a pilot valve mechanism configured to control a pressure of the fluid entering the two-position valve mechanisms and interior actuating chamber of the associated clutch or clutches, or any other mechanisms known in the art. It is further contemplated that a single clutch control valve 120-130 may be associated with more than one of friction clutches 80-90, and vice versa. A pressure relief valve 132 may be disposed within the manifold 104 downstream of the distribution lines 106-116 and configured to selectively pass fluid to the low pressure supply 102 in response to a pressure of the fluid within the manifold 104 exceeding a predetermined threshold.

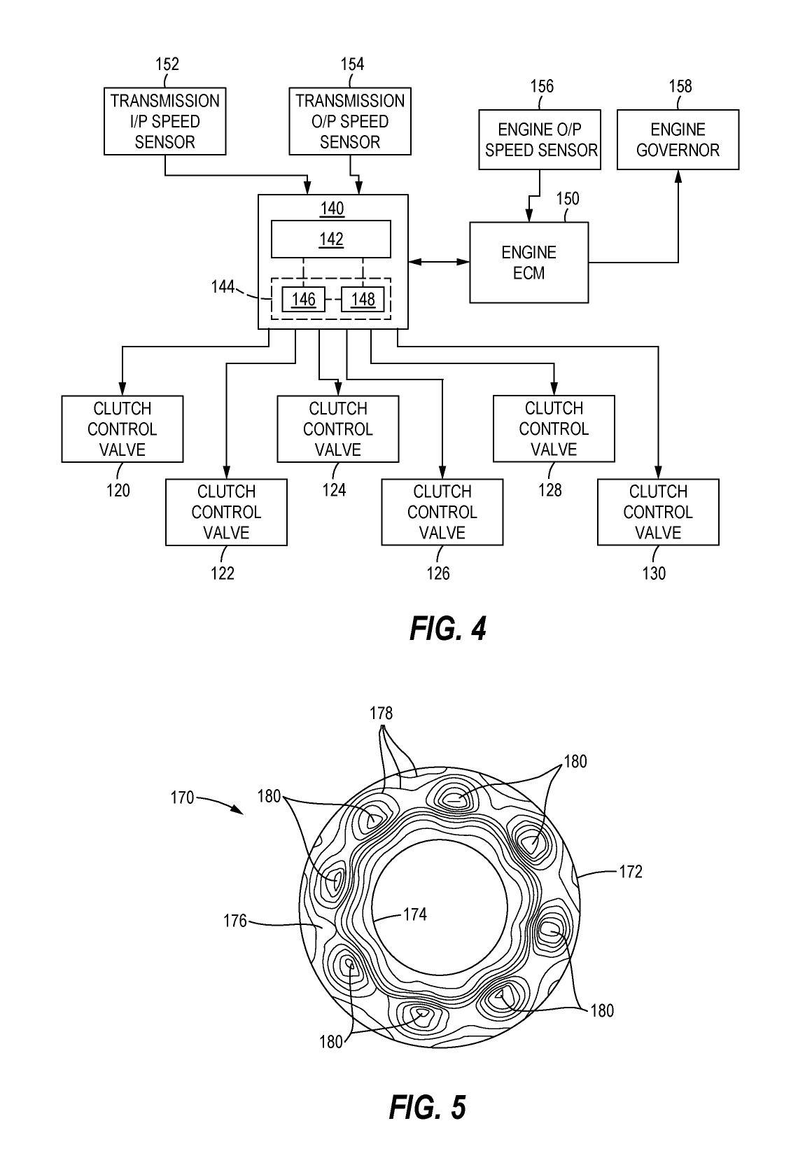

The clutch control valves 120-130 are among the components that form machine control systems for the machine 10. Referring to FIG. 4, an exemplary arrangement of electrical and control components of the power train of the machine 10 is shown with various control components that may be integrated into real time clutch local peak temperature prediction and clutch control in accordance with the present disclosure. An electronic control module (ECM) 140 may be capable of processing information received from monitoring and control devices using software stored at the ECM 140, and outputting command and control signals to the clutch control valves 120-130 and other devices of the machine 10. The ECM 140 may include a processor 142 for executing a specified program, which controls and monitors various functions associated with the machine 10. The processor 142 may be operatively connected to a memory 144 that may have a read only memory (ROM) 146 for storing programs, and a random access memory (RAM) 148 serving as a working memory area for use in executing a program stored in the ROM 146. Although the processor 142 is shown, it is also possible and contemplated to use other electronic components such as a microcontroller, an application specific integrated circuit (ASIC) chip, or any other integrated circuit device.

While the discussion provided herein relates to the functionality of a clutch and transmission control system, the ECM 140 may be configured to control other aspects of the operation of the machine 10 such as, for example, steering, dumping loads of material, actuating implements and the like. Moreover, the ECM 140 may refer collectively to multiple control and processing devices across which the functionality of the clutch and transmission control system and other systems of the machine 10 may be distributed. For clarity in the present example, the electrical and control components include an engine ECM 150 that may have a similar configuration as the ECM 140 and have an engine governor control module stored in memory that is executed to control the operation of the engine 14 in response to operator commands to provide power to drive the traction devices 22 and other working components of the machine 10. The ECMs 140, 150 may be operatively connected to exchange information as necessary to control the operation of the machine 10. Other variations in consolidating and distributing the processing of the ECMs 140, 150 as described herein are contemplated as having use in clutch and transmission control in accordance with the present disclosure.

The electronic and control components of the machine 10 may include sensing devices providing information to the ECMs 140, 150 for monitoring the status of components and systems of the machine 10 and executing control functions. The sensing devices may include sensors providing information about the current operational state of the power train of the machine 10. In general, such sensing devices may include speed, torque and position sensors transmitting signals corresponding to the rotational speeds, loads on and angular positions of various rotating components of the machine 10. Of particular relevance to the present clutch and transmission control strategy are component speed sensors. Consequently, the ECM 140 may be operatively connected to a transmission input speed sensor 152 and a transmission output speed sensor 154, among other speed sensing devices. The transmission input speed sensor 152 is operatively connected to the transmission input member or shaft 16 and transmits transmission input speed signals with values indicating the rotational speed of the transmission input shaft 16. The transmission output speed sensor 154 is operatively connected to the transmission output member or shaft 20 and transmits transmission output speed signals with values indicating the rotational speed of the transmission output shaft 20.

In a similar manner, the engine ECM 150 may be operatively connected to an engine output speed sensor 156. The engine output speed sensor 156 is operatively connected to the output shaft of the engine 14 and transmits engine output speed signals with values indicating the rotational speed of the engine output shaft. The engine output speed signals may be used by the engine governor control module in controlling the engine speed and power output. As may be necessary for clutch and transmission control, the engine output speed signals may be transmitted from the engine ECM 150 to the ECM 140 via an appropriate communication link as known in the art.

The ECMs 140, 150 are also operatively connected to various output and control device that may be the operational and controllable elements of the machine 10 for propulsion and braking, among other machine functions, that are controlled based on the information from the sensors 152-156. The output and control devices can include clutch actuator devices such as the clutch control valves 120-130 discussed above. The clutch control valves 120-130 are operatively connected to the ECM 140 for transmission of clutch control current to cause the clutch control valves 120-130 to open and allow the pressurized hydraulic fluid to flow to and cause engagement of the corresponding friction clutches 80-90.

The output and control devices may further include an engine governor 158. The engine governor 158 may be integrated into the engine 14 and may be a mechanical governor, an electronic governor implemented in software, or other appropriate conventional engine output control mechanism and control strategy. As illustrated, the engine governor 158 may be operatively connected to and receive engine control signals from the engine ECM 150 to cause the engine governor 158 increase, decrease or maintain the engine output speed and/or power output as dictated by operator inputs. The engine governor control module of the engine ECM 150 may determine values of operating parameters necessary for the engine 14 to produce a commanded output, such as fuel flow rates, intake air flow rates, engine output shaft speeds and the like, and transmit information in the engine control signals to cause the engine governor 158 to operate the engine 14 as commanded. As discussed further below, information related to the control of the engine governor 158 and, correspondingly, the engine 14 may be utilized in the clutch local peak temperature prediction and clutch control strategies in accordance with the present disclosure. Such information may be transmitted from the engine ECM 150 to the ECM 140 as necessary for execution of those strategies.

Under ideal conditions, the friction clutches 80-90 would heat uniformly such that energy dissipation in the friction clutches 80-90 may be used to calculate an average temperature distribution across the clutch components. However, the friction clutches 80-90 are sliding systems involving two or more sliding bodies, such as clutch plates, and frictional contact. Heat is not necessarily generated uniformly across the sliding bodies. Uneven heat generation produces non-uniform thermal-elastic distortion and further non-uniformity in the contact pressure distribution. When the sliding speed is sufficiently high, eventually the frictional load and heat generation can localize in a small region or regions of the contact area of the sliding surfaces in a phenomenon known as thermoelastic instability (TEI).

FIG. 5 illustrates an example of TEI in a component of one of the friction clutches 80-90. A clutch plate 170 of one of the friction clutches 80-90 may be disk-shaped and have an annular outer edge 172 and an annular inner edge 174 defining a central opening. A planar surface 176 faces and contacts a corresponding planar surface 176 of another clutch plate 170 when the corresponding friction clutch 80-90 is engaged, and the planar surfaces 176 may slide relative to each other when in contact and thereby generate frictional heat. Lines 178 on the planar surface 176 of the clutch plate 170 are isotherms illustrating an exemplary heat distribution across the planar surface 176. In general, the lines 178 proximate the outer edge 172 and the inner edge 174 represent cooler temperatures, with the temperatures represented by the lines 178 increasing as they move from the edges 172, 174 into the body of the clutch plate 170.

In the illustrated example, a plurality of hot spots 180 may form where the friction between the planar surfaces 176 is greatest and the local peak temperatures are at their maximum. The local peak temperatures at the hot spots 180 can be significantly greater than the average temperature that can be determined from the energy dissipation of the friction clutches 80-90. The cumulative effect of the high local peak temperatures at the hot spots 180 can lead to the need to replace the friction clutches 80-90 sooner than anticipated based on the clutch average temperatures. The methods and apparatus of the present disclosure provide a more accurate prediction of the operating conditions of the friction clutches 80-90 so that maintenance and replacement can be scheduled at the appropriate time during the useful life of the friction clutches 80-90.

### INDUSTRIAL APPLICABILITY

Several steps or components may be necessary to effectively utilize local peak temperatures to control the operation of clutches such as the friction clutches 80-90 and predict when maintenance or replacement may be necessary. First, a surrogate model of the friction clutch 80-90 can be developed that can determine the local peak temperatures based on the operating parameters associated with the friction clutch 80-90. With the surrogate model developed, the surrogate model may be used in real time at the ECM 140 to monitor the local peak temperatures and control the operation of the friction clutches 80-90 to prevent the local peak temperatures from exceeding a critical temperature above which the friction clutches 80-90 may be damaged. Finally, in addition to contemporaneous control, the local peak temperatures may be accumulated and analyzed over time to predict when the friction clutches 80-90 will require maintenance or replacement. These components are addressed in systems and apparatus in accordance with the present disclosure.

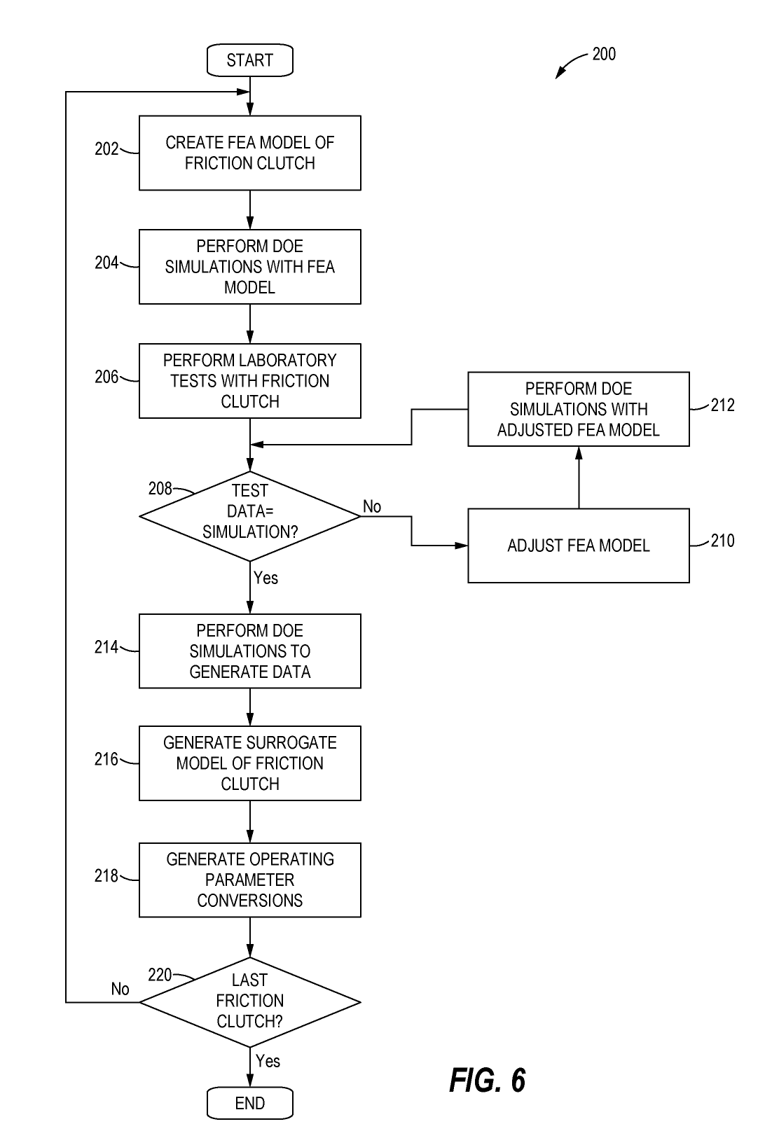

FIG. 6 illustrates an exemplary surrogate model generation routine 200 for building a surrogate model of one of the friction clutches 80-90 that will yield a local peak temperature from machine operating parameters of the friction clutches 80-90. The routine 200 may begin at a block 202 where a detailed, fully coupled thermal-mechanical finite element analysis (FEA) model is created that will simulate the clutch engagement process. The thermal-mechanical FEA model can be developed in the manner known in the art using any appropriate finite element software package that allows input and analysis of both mechanical and thermodynamic properties of the modeled device. The finite element software package may be a commercially available package, such as ANSYS®, ADINA®, Autodesk® Simulation and the like, or a custom developed software package.

With the thermal-mechanical FEA model developed, control may pass to a block 204 where Design of Experiments (DOE) are conducted using the thermal-mechanical FEA model at various levels of operating conditions to determine peak temperature locations or hot spots within the FEA model of the friction clutch 80-90. Operating conditions relevant to frictional engagement and heat generation that will occur in the friction clutch 80-90 may be entered into the FEA model to cause the FEA model to calculate local temperatures in the friction clutch 80-90. Relevant operating parameters can include the pressure in the clutch actuator forcing contact between the clutch plates 170 when the corresponding clutch control valve 120-130 is partially or fully open, torque loads on the components, and other conditions affecting the frictional engagement between clutch plates 170 and heat generation within the friction clutch 80-90. Each combination of input operating conditions will result in temperatures being calculated by the FEA model for the friction clutch 80-90. The output temperature distributions will provide indications of the locations of hot spots 180 with local peak temperatures within the friction clutch 80-90.

After the DOE simulations are performed for a variety of operating conditions and theoretical local peak temperature locations are identified, control may pass to a block 206 where laboratory tests are conducted on the friction clutch design to determine if the actual local peak temperatures occur at the theoretical locations. It is typically not practical to directly measure the temperature at locations within the friction clutch 80-90 such as the hot spots 180 on the clutch plate 170 when the transmission 12 is in the field, but such measurements can be made in the testing environment. Laboratory test may be run using the most relevant sets of operating conditions from the FEA model simulations. For example, operating conditions that resulted in local peak temperatures approximately equal to the critical temperature may be used. Alternatively or in addition, operating conditions providing the clearest indication of the locations of the hot spots 180 may be used. In further alternatives, any other set of operating conditions that are expected to generate meaningful test results can be used.

After the laboratory tests are performed and the test data is compiled at the block 206, control may pass to a block 208 where the laboratory test results are compared to the DOE simulation results to determine if the FEA model correlates to the friction clutch(es) used in the laboratory tests. The goal is to have the FEA model output match the actual thermal characteristics in the friction clutches 80-90. Consequently, the relevant thermodynamic test data is compared to the corresponding FEA simulation results. For example, the locations of the hot spots 180 with high local peak temperatures measured during the laboratory tests are compared to the hot spots 180 from the FEA simulations. If the hot spot locations from the tests differ from the hot spot locations from the FEA simulations by more than a statistically relevant distance, the FEA model may require adjustments to shift the hot spot locations in the simulations. As another example, the values of the local peak temperatures from the laboratory tests may be compared to the values from the FEA simulations. If the local peak temperatures in the test data are significantly higher or lower than in the FEA simulation, the thermodynamic material properties used for the components may require adjustment to move the local peak temperatures in the FEA simulations toward the local peak temperatures in the test data. Additional thermodynamic test data may be correlated with the FEA simulation results to determine whether additional adjustments to the FEA model are necessary.

If it is determined at the block 208 that the test data does not correlate to the FEA simulation results, control may pass to a block 210 where the parameters of the FEA model are adjusted as necessary to make the FEA model match the actual friction clutch 80-90. As suggested above, the adjustments can include those necessary to change the hot spot locations in the FEA model, to increase or decrease the local peak temperatures determined during the simulations, and any other changes to the thermal-mechanical properties necessary to match the FEA simulation results to the test data. After the FEA model is adjusted at the block 210, control may pass to a block 212 where simulations may be performed using the updated FEA model and various operating conditions in a similar manner as described for the original FEA model at the block 204.

As shown in the illustrated embodiment, after simulations are run on the updated FEA model at the block 212, control may pass back to the block 208 to compare the new FEA simulation results to the test data from the laboratory tests performed at the block 206. The comparison may be performed and the test data and simulations evaluated in a similar manner as described above. In alternative embodiments, control may pass from the block 212 back to the block 206 before the laboratory test may be performed to generate updated test data based on the most relevant sets of operating conditions from FEA simulations performed with the updated FEA model. In either embodiment, the test data and the FEA simulation results are compared as described above. If the FEA simulation results still do not correlate to the test data, the routine 200 may continue to iterate through FEA model adjustments at the block 210 and subsequent FEA model simulations at the block 212 until the FEA simulation results are sufficiently correlated to the laboratory test data.

When the simulation results are determined to correlate to the test data at the block 208, control may pass to a block 214 were a new DOE is executed with the correlated FEA model to generate a large amount of simulation data. In the new DOE, a wider range of operating condition combinations are used with the correlated FEA model than were executed with the FEA model at the block of 204. The operating conditions used in the new DOE can range from the most benign conditions at which minimal friction and heat generation occur to the harshest operating conditions where it may be expected that the local peak temperatures at the identified hot spots 180 will greatly exceed the critical temperature for the friction clutch 80-90. The results data generated from the new DOE simulations may provide a comprehensive view of the response of the friction clutch 80-90 across the spectrum of potential operating conditions that may be experienced in the field.

After the comprehensive simulation data is generated at the block 214, control may pass back to a block 216 where a surrogate model for the friction clutch 80-90 is generated using the simulation results from the block 214. The simulation data is used to train a machine learning process, such as a neural network or other type of machine-learning technique known in the art, to generate a surrogate model that can be executed in real time by the ECM 140 of the machine 10 to predict local peak temperatures in the friction clutch 80-90 under the current operating conditions. During the training, the machine learning process performs the necessary calculations on the simulation data to identify the critical combinations of operating conditions and streamline the local peak temperature discriminations that will be performed by the ECM 140. The resulting surrogate model when implemented in the ECM 140 of the machine 10 will receive values of the relevant operating parameters of the machine, process the operating parameter values using animal processing resources, and output local peak temperatures for the relevant locations within the friction clutch 80-90.

As discussed, operating parameter values of relevant operating parameters will be input into the surrogate model generated at the block 216 to determine the local peak temperatures of the friction clutch 80-90 in real time. Some of the relevant operating parameters may be readily measured and input to the surrogate model. For example, the rotational speeds of the input member or shaft 16 and the output member or shaft 20 may be measured by the transmission speed sensors 152, 154 discussed above and have the sensed speeds input to the surrogate model. Other operating parameter values are not readily directly measured in real time. For example, it may not be practical to place a pressure sensor inside the friction clutch 80-90 to sense a pressure in a hydraulic piston. Also, torque of the engine output shaft that determines a load on the friction clutch 80-90 may not be able to be directly measured without reducing the torque and the efficiency of the engine 14. Consequently, such operating parameter values must be derived from other measurable or known operating parameters.

When such derivations are required, control of the routine 200 may pass to a block 218 where operating parameter conversions are determined. Each of the operating parameters requiring derivation may have a corresponding conversion from measurable parameters developed. For example, a clutch pressure forcing the clutch plates 170 of the friction clutch 80-90 into engagement is generated based on the clutch control current transmitted to the corresponding clutch control valve 120-130. Consequently, a relationship will exist between the clutch control current and the clutch pressure. This relationship can be expressed in the conversion as a lookup table, a mathematical function or other expression wherein a clutch control current value is input and a clutch pressure is output for subsequent input to the surrogate model. The load on the friction clutch 80-90 may be calculated from the output torque of the engine 14 which, as discussed above, is not directly measured. However, the engine output torque can be calculated from engine operating parameters that are known to the engine ECM 150, such as the fuel flow rate from the engine governor control module and the engine output speed from the engine output speed sensor 156. When the engine torque is known, the load on the friction clutch 80-90 can be calculated based on the kinematics of the transmission 12 and the connection of the engine 14. This allows a clutch load conversion to be determined that receives operating parameters such as the fuel flow rate and the engine output shaft speed, and outputs a clutch load. Depending on the implementation, the operating parameter conversions can be integrated into the surrogate model, or may be standalone modules that are executed prior to the surrogate model and have their output operating parameters input to the surrogate model when performing clutch monitoring and control.

After any operating parameter conversions are determined at the block 218, control may pass to a block 220 to determine whether there are other friction clutches 80-90 for which a surrogate model must be generated. Friction clutches 80-90 with different physical configurations may generate heat differently and therefore require unique FEA models and surrogate models. Also, friction clutches 80-90 with the same physical configuration may be subjected to different sets of operating conditions by the components connected thereto. For example, the friction clutches 86, 88 may have the same physical configurations, but may be subjected to different clutch loads from the coupling 76 versus the planet carrier 54, respectively. In this case, the surrogate model for the friction clutch 86 may not provide accurate local peak temperatures for the friction clutch 88. In these situations, control may pass from the block 220 back to the block 202 to execute the surrogate model generation routine 200 for each friction clutch 80-90 requiring a unique surrogate model. After all the surrogate models are generated for all friction clutches 80-90, the routine 200 may terminate.

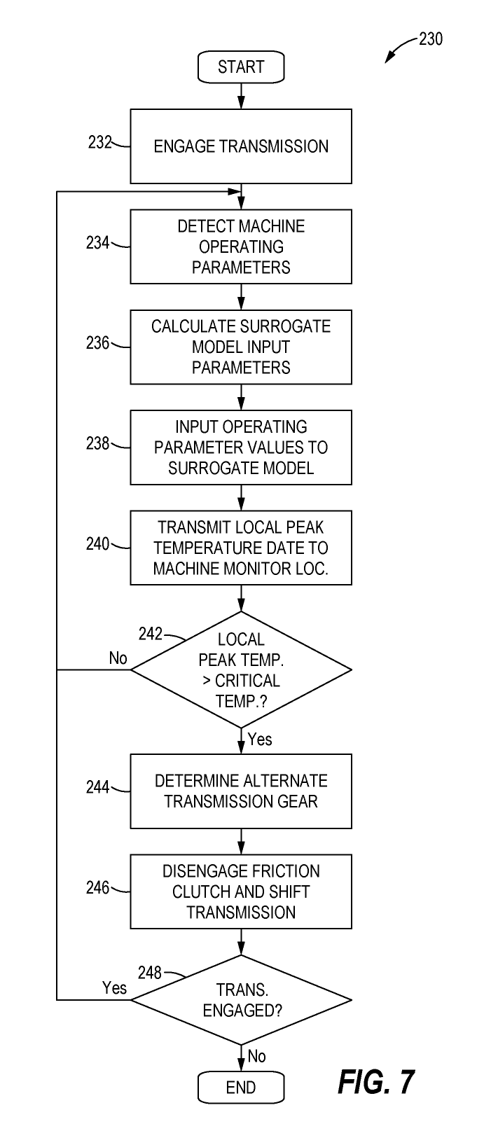

After being generated by the routine 200, the surrogate models may be loaded into the memory 144 of the ECM 140 for use in friction clutch monitoring and control during operation of the machine 10. FIG. 7 illustrates a flow diagram for an exemplary local peak temperature prediction and clutch control routine 230 utilizing the surrogate model for the corresponding friction clutch 80-90. The routine 230 may be executed in parallel for each of the friction clutches 80-90 having a unique surrogate model, or having the same surrogate model but different operating parameter values at a given time due to differences in engagement and disengagement in the various transmission gears, differences in loading from the components to which the friction clutches 80-90 are connected, and other factors. For purposes of discussion, the routine 230 will be described with reference to prediction and control of one of the friction clutches 80-90.

The routine 230 may begin at a block 232 where the transmission 12 is engaged due to manual input from an operator of the machine 10 or automatically by commands from the transmission control module of the ECM 140. The manual or automatic input can cause the ECM 140 to transmit clutch control currents to one or more of the clutch control valves 120-130 to engage the corresponding friction clutches 80-90 and shift the transmission 12 to one of the gears according to the truth table 92. For example, the ECM 140 may transmit control signals to the clutch control valves 120, 126, 130 to engage the friction clutches 80, 86, 90, respectively, to shift into the first forward gear 1F.

After the transmission 12 is engaged at the block 232, control passes to a block 234 where the machine operating parameters are detected and collected by the ECM 140. The machine operating parameters can include various operating parameters that can be used to determine the local peak temperatures in the friction clutch 80-90 as discussed above. The clutch control current transmitted to the clutch control valves 120-130 of the friction clutch 80-90 being monitored may be provided by the transmission control module being executed by the ECM 140. The transmission shaft speeds may be provided to the ECM 140 by the transmission speed sensors 152, 154, and/or the engine output shaft speed from the engine output speed sensor 156 may be forwarded by the engine ECM 150. Machine operating parameter used to determine the clutch load, such as the fuel flow rate for the engine 14 discussed above, may be provided from the engine governor control module at the engine ECM 150. Additional operating parameters relevant to local peak temperature prediction and clutch control may be determined and collected in similar manners.

As the machine control parameters are collected at the block 234, control may pass to a block 236 where any necessary calculations are performed to convert collected machine operating parameters to input parameters for the surrogate model of the friction clutch 80-90. Such calculations or conversions may be necessary where operating parameter conversions have been generated at the block 218 as discussed above. Consequently, the clutch control current value to the clutch control valve 120, 130 may be converted to a clutch pressure value, and the fuel flow rate and engine output shaft speed may be converted to an engine torque or a clutch load. Additional or alternative conversions may be performed. In alternative embodiments, where the conversions are integrated into the surrogate model of the friction clutch 80-90, the block 236 may be omitted as the collected machine operating parameters may be input directly to the surrogate model.

With the machine operating parameters collected at the block 234 and any necessary parameter conversions are performed at the block 236, control may pass to a block 238 where the surrogate model input parameters are input to the surrogate model to determine the local peak temperature of the friction clutch 80-90 at the current operating conditions. As discussed above, the surrogate model was developed from the FEA simulation data to determine the local peak temperature without executing the calculations necessary in an FEA model simulation. Therefore, the surrogate model does not require an undue amount of processing resources of the ECM 140. After executing the surrogate model with the current machine operating parameters at the block 238, control may pass to a block 240 where local peak temperature data output by the surrogate model is transmitted to a machine monitoring location that may be remote from the machine 10. In addition to addressing the current conditions and controlling the friction clutch 80-90 in real time, long-term tracking of the conditions to which the friction clutch 80-90 is subjected may be necessary to predict and schedule maintenance and replacement of the friction clutch 80-90. Proactive clutch maintenance and replacement are discussed further below.

In addition to transmitting data to the machine monitoring location at the block 240, control may pass to a block 242 where the local peak temperature of the friction clutch 80-90 is compared to a predetermined critical peak temperature. The critical peak temperature may be a temperature above which performance of the friction clutch 80-90 may degrade and a risk of excessive wear or other damage to the components of the friction clutch 80-90 may exist. If the local peak temperature output by the surrogate model is less than the critical peak temperature, then the friction clutch 80-90 is within the safe operating range and may continue to be engaged. Control may pass back to the block 234 to continue monitoring the machine operating parameters and the local peak temperature.

If the local peak temperature is greater than the critical peak temperature at the block 242, the friction clutch 80-90 should be disengaged to prevent further heat generation until the friction clutch 80-90 can cool down. However, the machine 10 is still being driven by the engine 14 and the engaged transmission 12. Therefore, it may be desirable for the disengagement of the friction clutch 80-90 to have minimal effect on the propulsion of the machine 10. Consequently, control may pass to a block 244 where the ECM 140 may determine an alternative gear to which the transmission 12 should shift where the friction clutch 80-90 is disengaged that minimizes the effect of the gear shift on the machine 10. As an example, the transmission 12 may be in the fourth foreword gear 4F as shown in the truth table 92 with friction clutches 80, 84, 88 engaged. When the local peak temperature for the friction clutch 84 is greater than the critical peak temperature, it may be preferable to shift the transmission 12 to the third forward gear 3F where the friction clutch 84 is disengaged instead of the fifth forward gear 5F where the friction clutch 84 is still engaged or the sixth forward gear 6F where the friction clutch is disengaged but the speed-to-torque ratio may be significantly different. In downshifting to the third forward gear 3F, the friction clutch 86 must be engaged while the friction clutches 80, 88 remain engaged. The strategy for shifting in response to exceeding the critical peak temperature may be predetermined and based solely on the friction clutch 80-90 that exceeds the critical peak temperature and the current gear, or may incorporate dynamic determination of the gear to which the transmission will be shifted that takes into account factors such as shaft speeds, engine torque and the like that will influence the reaction of the machine 10 to the gear shift.

After the alternate gear is determined, control passes to a block 246 where the transmission control module of the ECM 140 disengages the overheating friction clutch 80-90 and shifts the transmission 12 to the alternate gear. In the above example, the transmission control module would cut off the clutch control current to the clutch control valve 124 of the friction clutch 84, and transmit clutch control current to the clutch control valve 126 of the friction clutch 86 to engage the friction clutch 86 and downshift the transmission 12 from the fourth foreword gear 4F to the third forward gear 3F.

After the friction clutch 80-90 is disengaged and the transmission 12 is shifted at the block 246, control may pass to a block 248 to determine whether the ECM 140 is still receiving commands to engage the transmission 12. If the transmission 12 is to remain engaged, control may pass back to the block 234 to continue detecting and collecting machine operating parameter values and evaluating the local peak temperature of the friction clutch 80-90. If the transmission 12 is disengaged at the block 248, the routine 230 may cease execution until the transmission 12 is reengaged.

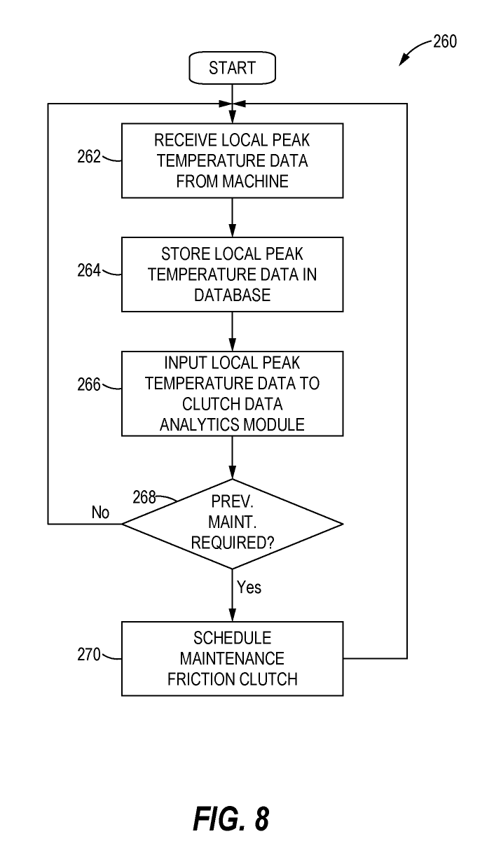

As discussed above, the local peak temperatures for the friction clutch 80-90 and associated machine operating parameter data may be transmitted to a machine monitoring location for accumulation and analysis. FIG. 8 illustrates one embodiment of a proactive clutch maintenance routine 260 that utilizes the transmitted local peak temperature data to determine when the friction clutch 80-90 should be maintained or replaced. The routine 260 may begin at a block 262 where the local peak temperature and machine operating parameter data are received at the machine monitoring location. The machine monitoring location may be a field office at a worksite with responsibility for the machine 10 at the worksite, or a central office that has responsibility for monitoring machines 10 operating at multiple worksites.

After the data is received at the block 262, control may pass to a block 264 where the local peak temperature and machine operating parameters are stored in a database along with previously received data for the friction clutch 80-90. The stored data provides a historical record of the operation of the friction clutch 80-90 and the amount and severity of the usage to which it has been subjected since being placed into service.

In addition to storing the local peak temperature data in the database, control may pass to a block 266 where the data is input into a clutch data analytics module. The clutch data analytics module may use the current local peak temperature data along with historical data from the database to assess the present condition of the friction clutch 80-90. The clutch data analytics module may be programmed to utilize information such as the service time since the transmission 12 was put into service, total operating hours where the transmission 12 has been engaged to drive the machine 10, shaft speeds, loads, peak temperatures and other data influencing the wear and tear on the friction clutch 80-90 to determine whether the cumulative usage of the friction clutch 80-90 has reached a limit where preventive maintenance should be scheduled. Historical data and experience with previous friction clutches may serve as a basis for weighting the various factors for their influence on the useful life of the friction clutches 80-90, and inputting the weighting into the configuration of the clutch data analytics module.

The output of the clutch data analytics module is evaluated at a block 268. If the data indicates that the friction clutch 80-90 is not ready for maintenance, control may pass back to the block 262 to await subsequent transmissions of local peak temperature data. If the friction clutch 80-90 has reached the point in its useful life where preventive maintenance should be performed, control may pass to a block 270 where preventive maintenance on the friction clutch 80-90 is scheduled. The machine monitoring location may have a maintenance scheduling routine plan for the appropriate time and location for maintenance. The maintenance schedule routine may utilize information such as maintenance personnel availability, maintenance location availability, parts availability and order lead time, usage schedule for the machine 10 and other logistical information to determine an optimal time it to take the machine 10 out of service for maintenance on the friction clutch 80-90. The maintenance schedule routine may also transmit notices to the machine operators, maintenance staff, facilities schedulers and others that you plan for the scheduled maintenance. After the maintenance is scheduled by the maintenance scheduling routine at the block 270, control may pass back to the block 262 to await subsequent transmissions of local peak temperature data.

Determination and use of the local peak temperatures of the friction clutches 80-90 in monitoring and controlling the clutches 80-90 in the transmission 14 as disclosed herein can improve the ability to predict clutch durability and performance both in real time and over the long term. In real time, knowing the local peak temperatures at hot spot locations can provide more accurate identification of impending failure of the friction clutches 80-90 and the ability to take remedial steps before failure occurs than is possible when using an average temperature distribution. Dangerous conditions can be overlooked when only the average temperature is being evaluated. In other situations, uncertainty through the use of average temperatures may result in falsely identifying dangerous conditions by setting a threshold average temperature very low to ensure that all potentially dangerous conditions are covered even when the local peak temperatures are not close to being critical. The increased precision offered by evaluating local peak temperatures correspondingly increases the precision in identifying dangerous conditions and minimizing corrective actions to only those situations that truly require disengagement of the friction clutches 80-90. Similar improvements may be realized over the long term where knowledge of the local peak temperatures can yield more accurate assessment of long term wear and tear on the friction clutches 80-90 and prediction of the approach of the ends of the useful lives of the friction clutches 80-90.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A method for determining a local peak temperature for a friction clutch in a machine and controlling engagement of the friction clutch using the local peak temperature, wherein the local peak temperature is a temperature at a hot spot of the friction clutch, the method for determining comprising:
determining current operating parameter values of operating parameters of the machine;
determining a current local peak temperature for the friction clutch based on the current operating parameter values;
comparing the current local peak temperature for the friction clutch to a critical peak temperature for the friction clutch;
maintaining engagement of the friction clutch in response to determining that the current local peak temperature is less than the critical peak temperature; and
disengaging the friction clutch in response to determining that the current local peak temperature is greater than the critical peak temperature.

2. The method of claim 1, wherein determining the current local peak temperature for the friction clutch comprises inputting the current operating parameter values into a surrogate model of the friction clutch, wherein the surrogate model is configured to receive the current operating parameter values as inputs and use the current operating parameters values to derive the current local peak temperature.

3. The method of claim 1, wherein the current operating parameter values include a clutch control current value of a clutch control current transmitted to a clutch actuator to create a clutch pressure at the friction clutch, a clutch load applied to the friction clutch and a transmission shaft speed of a transmission of the machine of which the friction clutch is a component.

4. The method of claim 1, wherein determining the current operating parameter values comprises:
determining a clutch control current value for a clutch control current transmitted to a clutch actuator of the friction clutch; and
converting the clutch control current value to a clutch pressure value of a clutch pressure created in the friction clutch by the clutch actuator in response to the clutch control current, and
wherein determining the current local peak temperature comprises determining the current local peak temperature based on the clutch pressure value.

5. The method of claim 1, wherein the friction clutch is a component of a transmission of the machine, wherein determining the current operating parameter values comprises sensing a transmission shaft speed value of a transmission input shaft of the transmission, and wherein determining the current local peak temperature comprises determining the current local peak temperature based on the transmission shaft speed value.

6. The method of claim 1, wherein determining the current operating parameter values comprises:
determining an engine torque value for an engine torque output by an engine of the machine that is operatively connected to the friction clutch; and
converting the engine torque value to a clutch load value of a clutch load transmitted to the friction clutch from the engine, and
wherein determining the current local peak temperature comprises determining the current local peak temperature based on the clutch load value.

7. The method of claim 1, wherein the friction clutch is a component of a transmission of the machine that can be shifted into multiple gears, and wherein disengaging the friction clutch in response to determining that the current local peak temperature is greater than the critical peak temperature comprises:
determining a different gear of the transmission in which the friction clutch is not engaged; and
shifting the transmission to the different gear so that the friction clutch is disengaged.

8. A machine comprising:
an engine;
traction devices;
a friction clutch operatively connecting the engine to the traction devices and selectively engageable to transmit torque output by the engine to the traction devices;
a friction clutch actuator operatively connected to friction clutch and actuatable in response to a clutch control current to selectively engage and disengage the friction clutch; and
an electronic control module (ECM) operatively connected to the engine and the friction clutch, the ECM being programmed to:
determine current operating parameter values of operating parameters of the machine,
determine a current local peak temperature for the friction clutch based on the current operating parameter values,
compare the current local peak temperature for the friction clutch to a critical peak temperature for the friction clutch,
transmit the clutch control current to the friction clutch actuator to maintain engagement of the friction clutch in response to determining that the current local peak temperature is less than the critical peak temperature, and
cease transmitting the clutch control current to the friction clutch actuator to disengage the friction clutch in response to determining that the current local peak temperature is greater than the critical peak temperature.

9. The machine of claim 8, comprising a memory operatively connected to the ECM and storing a surrogate model of the friction clutch configured to receive the current operating parameter values as inputs and derive the current local peak temperature, wherein the ECM is programmed to determine the current local peak temperature for the friction clutch by inputting the current operating parameter values into the surrogate model of the friction clutch.

10. The machine of claim 8, wherein the ECM is programmed to determine a clutch control current value for the clutch control current transmitted to the friction clutch actuator, convert the clutch control current value to a clutch pressure value of a clutch pressure created in the friction clutch by the friction clutch actuator in response to the clutch control current, determine the current local peak temperature based on the clutch pressure value.

11. The machine of claim 8, wherein the ECM is programmed to determine an engine torque value for an engine torque output by the engine, convert the engine torque value to a clutch load value of a clutch load transmitted to the friction clutch from the engine, and determine the current local peak temperature based on the clutch load value.

12. The machine of claim 8, wherein the machine comprises a transmission that can be shifted into multiple gears and the friction clutch is a component of the transmission, and wherein the ECM being programmed to disengaging the friction clutch in response to determining that the current local peak temperature is greater than the critical peak temperature includes the ECM being programmed to:
determine a different gear of the transmission in which the friction clutch is not engaged; and
shift the transmission to the different gear so that the friction clutch is disengaged.

13. A method for determining a local peak temperature for a friction clutch in a machine and controlling engagement of the friction clutch using the local peak temperature, wherein the local peak temperature is a temperature at a hot spot of the friction clutch, the method for determining comprising:
detecting operating parameters of the machine;
inputting operating parameter values corresponding to the operating parameters into a surrogate model of the friction clutch;
determining, in the surrogate model, a current local peak temperature for the friction clutch;
outputting, from the surrogate model, the current local peak temperature for the friction clutch;
comparing the current local peak temperature for the friction clutch to a critical peak temperature for the friction clutch;
maintaining engagement of the friction clutch in response to determining that the current local peak temperature is less than the critical peak temperature; and
disengaging the friction clutch in response to determining that the current local peak temperature is greater than the critical peak temperature.

14. The method of claim 13, wherein the friction clutch is a component of a transmission of the machine.

15. The method of claim 13, wherein the machine has a plurality of friction clutches, and the method for determining comprises performing the detecting, inputting, determining, outputting, comparing, maintaining and disengaging steps for each of the plurality of friction clutches.

16. The method of claim 13, wherein one of the operating parameters of the machine is a clutch control current for a clutch actuator of the friction clutch, and wherein the method for determining comprises converting a clutch control current value to a clutch pressure value of the clutch actuator.

17. The method of claim 16, wherein inputting the operating parameter values into the surrogate model comprises inputting the clutch pressure value into the surrogate model.

18. The method of claim 13, wherein the friction clutch is a component of a transmission of the machine, wherein one of the operating parameters of the machine is a transmission shaft speed of an input shaft of the transmission, wherein the method for determining comprises sensing the transmission shaft speed of the input shaft, and wherein inputting the operating parameter values into the surrogate model comprises inputting a transmission shaft speed value into the surrogate model.

19. The method of claim 13, wherein the machine includes an engine having an engine output shaft operatively connected to the friction clutch, wherein the method for determining comprises determining an engine torque on the engine output shaft, and wherein inputting the operating parameter values into the surrogate model comprises inputting an engine torque value into the surrogate model.

20. The method of claim 13, wherein the friction clutch is a component of a transmission of the machine that can be shifted into multiple gears, and wherein disengaging the friction clutch in response to determining that the current local peak temperature is greater than the critical peak temperature comprises:
determining a different gear of the transmission in which the friction clutch is not engaged; and
shifting the transmission to the different gear so that the friction clutch is disengaged.
